(19) United States
(12) Patent Application Publication
(10) Pub. No.: US 2023/0174047 A1
(43) Pub. Date: Jun. 8, 2023

(54) LEAN OPERATING HYBRID GASOLINE ENGINE

(71) Applicant: JAGUAR LAND ROVER LIMITED, Whitley, Coventry Warwickshire (GB)

(72) Inventors: Jack JOHNSON, Coventry, Warwickshire (GB); Lyn MCWILLIAM, Coventry, Warwickshire (GB); John GEDDES, Coventry, Warwickshire (GB); Bryn LITTLEFAIR, Coventry, Warwickshire (GB); Thomas JOHNSON, Stratford-upon-Avon, Warwickshire (GB)

(21) Appl. No.: 17/916,569

(22) PCT Filed: Mar. 26, 2021
(86) PCT No.: PCT/EP2021/057916

§ 371 Date: Oct. 1, 2022

(30) Foreign Application Priority Data
Apr. 2, 2020 (GB) 2004883.1

(51) Int. Cl. B60W 20/16; B60W 10/06; B60W 10/08; B60W 10/26

(52) U.S. Cl. CPC B60W 20/16; B60W 10/06; B60W 10/08; B60W 10/26; B60W 2510/0666; B60W 2710/086; B60W 2710/0622

(57) ABSTRACT

An engine control unit (400) for a full hybrid engine (100, 101) is provided. The full hybrid engine (100, 101) comprises an internal combustion engine (110) and an electric motor (120). The internal combustion engine (110) is coupled to the drivetrain via a clutch (130). The engine control unit (400) is configured to operate the internal combustion engine (110) in a lean-burn mode, to determine a current load level of the full hybrid engine (100, 101), and to compare the current load level to a lean-burn load threshold (210). The lean-burn load threshold (210) defines a load level below which stable operation of the internal combustion engine (110) in the lean-burn mode is impossible and/or undesirable. If the current load level of the full hybrid engine (100, 101) is below the lean-burn load threshold (210), the internal combustion engine (110) is decoupled from the drivetrain and the full hybrid engine (100, 101) is operated in an electric mode.

### TECHNICAL FIELD

The present disclosure relates to a lean operating hybrid gasoline engine. Aspects of the invention relate to an engine control unit, to an internal combustion engine, to a full hybrid engine and to powertrain and a vehicle with such an engine. The present disclosure further relates to a method of operating a full hybrid engine for a drivetrain of a vehicle

### BACKGROUND

In classic internal combustion engines, gasoline burns best when it is mixed with air in the proportions of 14.7:1 (lambda = 1). Most modern gasoline engines used in vehicles tend to operate at or near this so-called stoichiometric point for most of the time. Ideally, when burning fuel in an engine, only carbon dioxide (CO₂) and water (H₂O) are produced. In practice, the exhaust gas of an internal combustion engine also comprises significant amounts of carbon monoxide (CO), nitrogen oxides (NO_{X}) and unburned hydrocarbons. It is desirable to increase fuel efficiency and reduce unwanted emissions.

One possible route for increasing fuel efficiency is to burn the fuel with an excess of air. Burning fuel in such an oxygen-rich environment is usually called lean-burning. Typical lean-burn engines may mix air and fuel in proportions of, for example, 20:1 (lambda > 1.3) or even 30:1 (lambda > 2). Advantages of lean-burn engines include, for example, that they produce lower levels of CO₂ and hydrocarbon emissions by better combustion control and more complete fuel burning inside the engine cylinders. The engines designed for lean burning can employ higher compression ratios and thus provide more efficient fuel use and lower exhaust hydrocarbon emissions than conventional gasoline engines. Additionally, lean-burn modes help to reduce throttling losses, which originate from the extra work that is required for pumping air through a partially closed throttle. When using more air to burn the fuel, the throttle can be kept more open when the demand for engine power is reduced.

Lean burning of fuel does, however, also come with some technical challenges that have to be overcome to provide an engine that is suitable and optimised for efficiently burning hydrocarbons in an oxygen-rich environment. For example, if the mixture is too lean, the engine may fail to combust. At low loads and engine speeds, reduced flammability may affect the stability of the combustion process and introduce problems with engine misfire. A lower fuel concentration also leads to less power output. Because of such disadvantages, lean burn is currently only used for part of the engine map and most lean-burning modern engines, for example, tend to cruise and coast at or near the stoichiometric point.

It is an aim of the present invention to address one or more of the disadvantages associated with prior art lean-burning engines.

### SUMMARY OF THE INVENTION

Aspects and embodiments of the invention provide an engine control unit, an internal combustion engine, a full hybrid engine, a powertrain, a vehicle and a method as claimed in the appended claims. The lean-burn engine may be suitable for use with gasoline as described herein. Alternatively or in addition thereto it will be appreciated that the lean-burn engine may be suitable for use with other fuels, such as hydrogen, for example. Aspects and embodiments of the invention are defined in the context of lean-burn gasoline but it will be appreciated that the fuel type can be substituted.

According to an aspect of the present invention there is provided an engine control unit for a full hybrid engine. The full hybrid engine comprises an internal combustion engine and an electric motor, the internal combustion engine being coupled to the drivetrain via a clutch. The engine control unit is configured to
operate the internal combustion engine in a lean-burn mode,
determine a current load level of the full hybrid engine,
compare the current load level to a lean-burn load threshold, the lean-burn load threshold defining a load level below which stable operation of the internal combustion engine in the lean-burn mode is impossible and/or undesirable, and
if the current load level of the full hybrid engine is below the lean-burn load threshold, decouple the internal combustion engine from the drivetrain and operating the full hybrid engine in an electric mode.

The transition between the lean-burn mode and the electric mode is marked by the lean-burn load threshold, which is hereby defined as the load level below which stable operation of the internal combustion engine in the lean-burn mode is impossible and/or undesirable. ‘Impossible’ may mean that reduced flammability of the charge makes lean combustion technically completely impossible, or at least too unpredictable and unstable to be suitable for effective use of the internal combustion engine. Lean-burn operation of the internal combustion engine may be ‘undesirable’, e.g., because of relatively low fuel efficiency or high NOₓ or CO emissions. Similarly, lean operation will be ‘undesirable’ when the exhaust gas temperatures are too low to allow such emissions to be effectively dealt with by the aftertreatment system. Other possible reasons for lean-burn operation not being desirable may, for example, be an excess of other undesirable or legislated emissions, (temporary) noise restrictions, low filling levels of the fuel tank, or a simple user preference to drive in the electric mode.

With the engine control unit according to the invention, the inventors have provided a clean and efficient internal combustion engine that can run in a clean and efficient, low emission, lean-burn mode whenever the internal combustion engine is running. The electric motor takes over in those regions of the engine map where lean-burn combustion is not possible or desirable. In addition thereto, the electric motor may be used to improve to enhance the power output, to improve its efficiency and/or to reduce its emissions when the engine is running in the lean-burn mode.

In an embodiment, the engine control unit is configured to:
operate the full hybrid engine in the electric mode,
determine the current load level of the full hybrid engine,
compare the current load level to the lean-burn load threshold, and
if the current load level of the full hybrid engine is above the lean-burn load threshold, couple the internal combustion engine to the drivetrain and operating the internal combustion engine in the lean-burn mode.

This allows the engine to switch to the lean-burn mode as soon as possible, thereby keeping the batteries powering the electric motor to maintain their charge for longer. Preferably, the batteries are at least partly recharged while the engine is running in lean-burn mode, for example when the vehicle is decelerating or coasting.

Optionally, the engine control unit is configured to determine a current RPM of the full hybrid engine, and to determine the lean-burn load threshold in dependence of the current RPM. At higher engine RPM, lean-burn combustion engines tend to be able to run efficiently with low emissions at lower engine loads then when running at lower engine RPM. By making the lean-burn threshold dependent on the engine RPM, the engine is allowed to run in lean-burn mode over a larger portion of the engine map.

The current load level of the full hybrid engine may, for example, be determined in dependence of an electronic signal representative of a current position of an accelerator pedal and/or in dependence of an electronic signal representative of a current speed control setting of a cruise control system. A torque model may be used to determine the current load level and/or a current RPM of the full hybrid engine.

In an embodiment, the engine control unit is configured to determine a current NOₓ concentration in an exhaust stream of the internal combustion engine, while the internal combustion engine is operating in the lean-burn mode. The thus obtained current NOₓ concentration may, for example, be compared to a NOₓ threshold. If the current NOₓ concentration is above the NOₓ threshold, the engine control unit may operate the clutch to decouple the internal combustion engine from the drivetrain and to operate the full hybrid engine in the electric mode. This will, for example, ensure that the engine will not continue to emit excessive amounts of NOₓ when, for whatever reason, the NOₓ emissions are higher than what would have been expected at the current engine load and RPM. Optionally, the lean-burn load threshold is re-calibrated based on the current load level and the current NOₓ concentration. This may, for example, be useful if the engine’s emission characteristics change over time, with temperature or in dependence of the exact composition of the fuel that is being burnt.

In an embodiment, the engine control unit is configured to determine a current NOx concentration in an exhaust stream of the internal combustion engine, while the internal combustion engine is operating in the lean-burn mode. The thus obtained current NOx concentration may, for example, be compared to a NOx threshold. If the current NOx concentration is above the NOx threshold, the engine control unit may operate the electric motor to provide drive or regenerative torque in order to change the operating point of the internal combustion engine to reduce the NOx concentration.

According to an aspect of the invention, an internal combustion engine is provided comprising an engine control unit as described above. The internal combustion engine may be part of a full hybrid engine for a drivetrain of a vehicle, the full hybrid engine further comprising at least one electric motor and a clutch for coupling the internal combustion engine to the drivetrain. The full hybrid engine may further comprise a generator, mechanically coupled to the internal combustion engine and electrically coupled to the electric motor and/or a battery pack of the vehicle. The full hybrid engine may be part of a powertrain for a vehicle.

According to a further aspect of the invention, a method is provided of operating a full hybrid engine for a drivetrain of a vehicle. The full hybrid engine comprises an internal combustion engine and an electric motor, the internal combustion engine being coupled to the drivetrain via a clutch. The method comprises:
operating the internal combustion engine in a lean-burn mode,
determining a current load level of the full hybrid engine,
comparing the current load level to a lean-burn load threshold, the lean-burn load threshold defining a load level below which stable operation of the internal combustion engine in the lean-burn mode is impossible and/or undesirable, and
if the current load level of the full hybrid engine is below the lean-burn load threshold, decoupling the internal combustion engine from the drivetrain and operating the full hybrid engine in an electric mode.

This method provides all the advantages and can use the optional features described above for the engine control unit according to the invention.

According to a further aspect of the invention there is provided an engine control unit for a battery electric vehicle, the battery electric vehicle comprising an internal combustion engine, an electric motor, a battery pack, and a generator, the generator being mechanically coupled to the internal combustion engine and electrically coupled to the electric motor and/or the battery pack, the engine control unit being configured to operate the internal combustion engine, determine a current load level of the internal combustion engine, compare the current load level to a lean-burn load threshold, the lean-burn load threshold defining a load level below which stable operation of the internal combustion engine in the lean-burn mode is impossible and/or undesirable, and if the current load level of the internal combustion engine is below the lean-burn load threshold, increase the current load level for charging the battery pack.

The engine control unit may be part of an internal combustion engine or an internal combustion engine system.

According to a further aspect of the invention there is provided a powertrain for a battery electric vehicle, the powertrain comprising an internal combustion engine, an electric motor, a battery pack, generator, mechanically coupled to the internal combustion engine and electrically coupled to the electric motor and/or the battery pack, and an engine control unit according to previous aspects of the invention.

The powertrain may be part of a vehicle, such as a hybrid vehicle, a series hybrid vehicle or a battery electric vehicle,

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a vehicle and vehicle powertrain wherein the invention may be advantageously used;

FIG. 2 shows a variation of the vehicle powertrain of FIG. 1;

FIG. 3 shows a schematic representation of another vehicle powertrain wherein the invention may be advantageously used;

FIG. 4 shows a variation of the vehicle powertrain of FIG. 3;

FIG. 5 shows an alternative embodiment of a vehicle powertrain with a lean-burn engine;

FIG. 6 schematically shows an engine map for use with an embodiment of the invention;

FIG. 7 shows a flow diagram of a possible method according to the invention;

FIG. 8 shows a simplified example of a control system such as may be adapted in accordance with an embodiment of the invention;

### DETAILED DESCRIPTION

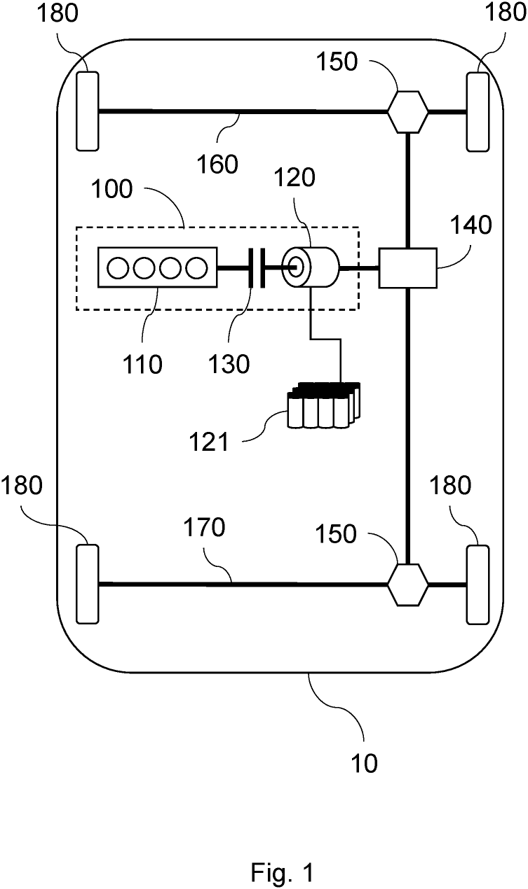

A powertrain in accordance with an embodiment of the present invention is described herein with reference to the accompanying FIG. 1. The powertrain is configured to provide the power needed to drive the wheels 180 on the front axle 160 and rear axle 170 of a four-wheel drive vehicle. It is, however, noted that the invention would be similarly useful when applied in, for example, a front-wheel or rear-wheel drive vehicle. The mechanical power needed for driving the vehicle is generated by a hybrid engine 100 which, in this four-wheel drive vehicle, is coupled to the front and rear axle 160, 170 via a transmission 140 and two differentials 150. In a front-wheel or rear-wheel drive vehicle, only one differential 150 will be needed.

The hybrid engine 100 comprises an internal combustion engine 110 and an electric motor 120. The internal combustion engine 110 burns gasoline to convert heat into mechanical power. To enjoy the benefits of the current invention, the internal combustion engine 110 is configured for operating under lean conditions, i.e. burning the gasoline with an excess of air in the air-fuel mixture (also called charge). The electric motor 120 is powered by a battery pack 121 and converts electric power into mechanical power. When driven by an output shaft of the internal combustion engine 110, the electric motor 120 can be used as a generator for charging the battery pack. In addition thereto, the battery pack 121 may, for example, be chargeable via an external charger connected to the power grid or by via photovoltaic cells integrated in the bodywork of the vehicle.

The hybrid engine 100 used in this embodiment of the invention is of the P2 type, which means that the electric motor 120 is coupled to the output shaft of the internal combustion engine 110 via a clutch 130. When the clutch 130 is opened, the internal combustion engine 110 is decoupled from the drivetrain and the vehicle is propelled by the electric motor 120 only. When the clutch 130 is closed, power generated by the internal combustion engine 110 can be used for driving the vehicle. The vehicle 10 may then be driven by the combustion engine 110 only or assisted by the electric motor 120. Alternatively, the combustion engine 110 may be used to generate more power than needed for driving the vehicle and the excess power can be used to let the electric motor 120 convert mechanical power into electricity that can, for example, be used for charging the battery pack 121. Because the vehicle can be run only on the combustion engine 110, only on the electric motor 120, or on a combination of both, this type of hybrid engine 100 is also called a full hybrid engine 100.

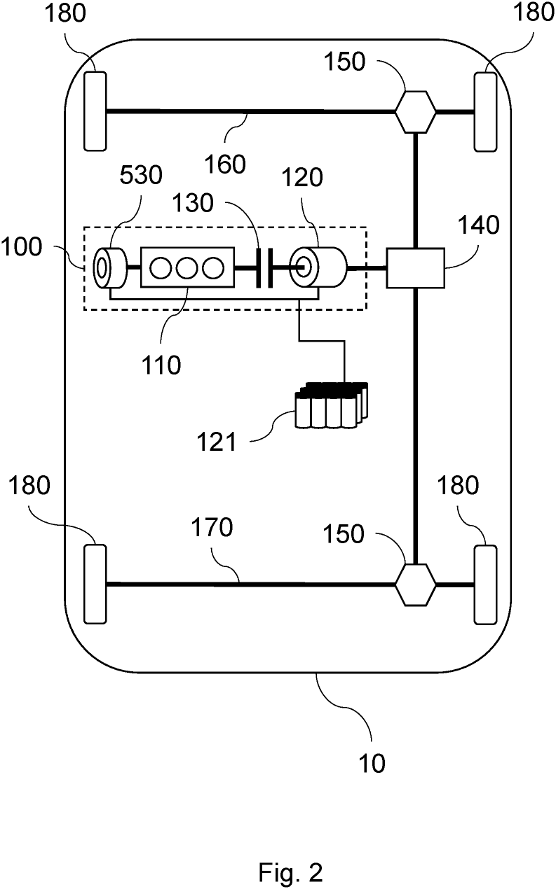

FIG. 2 shows a variation of the vehicle powertrain of FIG. 1. Here, a separate generator 530 is connected to the internal combustion engine 110. The generator 530 can be used to power the electric motor 120 and/or to charge the battery pack 121. Unlike the electric motor 120, the generator 530 can be used when the engine 110 is uncoupled from the drivetrain. Although not shown, an additional clutch may be provided to uncouple the generator 530 from the engine 110, when the generator 530 is not used to generate electrical power.

When the clutch 130 is opened and the engine 110 is uncoupled from the electric motor 120 and the drivetrain, it may continue to run in a lean-burn mode to drive the generator 530 and thereby charge the battery pack 121 or power the electric motor 120. When coupled to the drivetrain, a controlled increase of the total engine load, above the engine load that would be needed for driving the vehicle, may help to push the engine 110 into an operational mode wherein it can operate lean. This excess engine load is then used to drive the generator 530 and thereby charge the battery pack 121.

It is noted that, although in FIGS. 1 and 2 a hybrid engine 100 of the P2 type is shown, the invention is equally useful for other types of hybrid engines (e.g. P3 or P4) wherein the internal combustion engine can be decoupled from the drivetrain when the vehicle if fully powered by the electric motor.

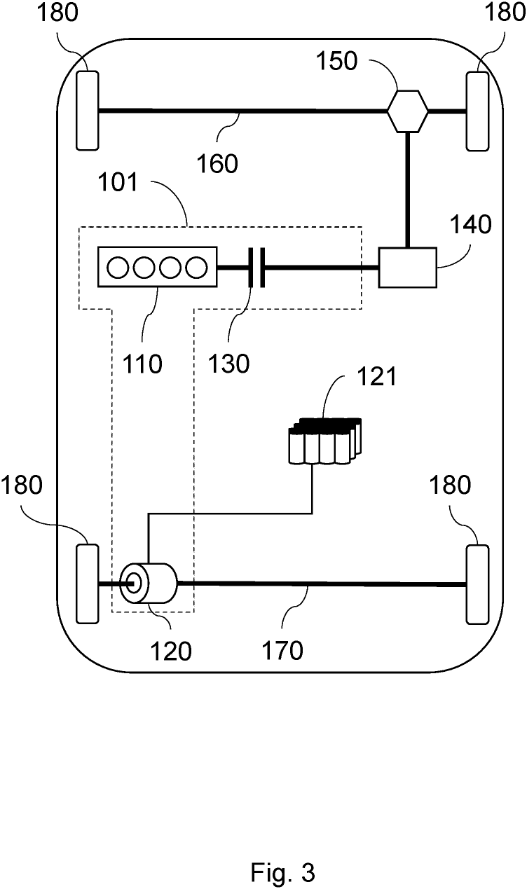

An example of a P4 type hybrid engine 101 is shown in FIG. 3. Here, the internal combustion engine 110 is coupled to the transmission 140 via a clutch 130 to drive the front wheels. The electric motor 120 is directly coupled to the rear axle 170. The powertrain shown in this figure can be run in four-wheel drive mode by the internal combustion engine 110, assisted by the electric motor 120 to provide torque to the rear axle 170. In a fully electric mode, the internal combustion engine 110 is decoupled from the drivetrain and the vehicle driven by the electric motor 120 on the rear axle 170 only. In such a configuration, the internal combustion engine 110 and the electric motor 120 are only coupled to each other via the road and the wheels 180 of the vehicle. It is noted that, in other embodiments, a coupling between the transmission 140 and the rear axle 170 may be provided and may include a clutch for selectively uncoupling the transmission 140 from the rear axle 170.

The internal combustion engine 110 may additionally be coupled to a generator (not shown), which could, for example, be used to charge the battery pack 121 and/or power the electric motor 120. This will typically be useful when the vehicle 10 is driven at the rear axle 170 only but can also be done while in four-wheel drive or front-wheel drive mode. When in front-wheel drive mode, the generator is only used for charging the battery pack 121. In rear-wheel or four-wheel drive mode, the generator 530 can be used for powering the electric motor 120 and/or charging the battery pack 121.

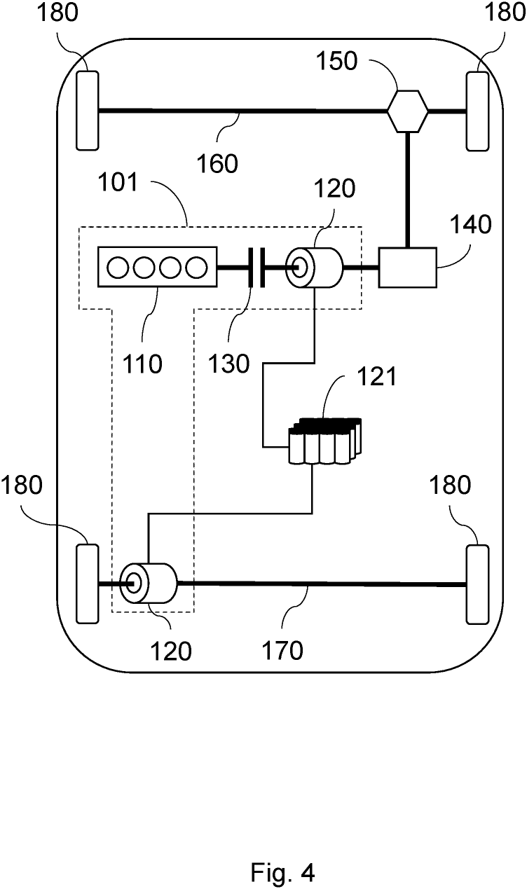

FIG. 4 shows a variation of the vehicle powertrain of FIG. 3. Here, an additional electric motor 120 is provided between the clutch 130 and the transmission 140. The front axle 160 is thus driven by a full hybrid engine similar to the one shown in FIG. 1, while the rear axle 170 is powered by a separate electric motor 120 only. The front and rear axles 160, 170 are only coupled to each other via the road and the wheels 180 of the vehicle.

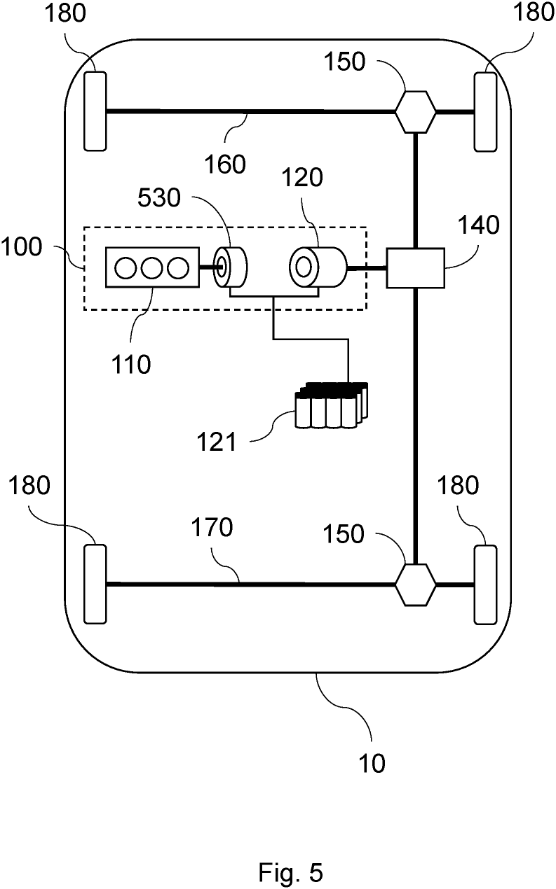

FIG. 5 shows an alternative embodiment of a vehicle powertrain with a lean-burn engine. In this embodiment, the internal combustion engine 110 is not mechanically coupled to the drivetrain. Instead, the engine 110 is connected to a generator 530 that produces electrical power when driven by the engine 110. The electrical power generated by the generator 530 can be put to direct use for enabling the electric motor 120 to drive the transmission 140 or to charge the battery pack 121, such that the electrical power stored by the battery pack 121 can be used later for driving the electric motor 120. Because this vehicle is always driven by the electric motor 120 and cannot be driven exclusively by the internal combustion engine 110, it is not a full hybrid but an electric vehicle. The internal combustion engine 110 in such an electric vehicle is typically called ‘range extender’ or ‘auxiliary power unit’ (APU). Another important difference with the embodiments of FIGS. 1 and 2 is that the RPM of the electric motor 120 is fully independent of the RPM of the internal combustion engine 110. Since the RPM of the internal combustion engine 110 is independent from the electric motor 120, the RPM of the internal combustion engine 110 is also independent from the RPM of the road wheels, thus enabling the internal combustion engine 110 to be run at an RPM that is not related to the speed of the vehicle.

The amount of electrical power generated by the generator 530 is controlled in dependence of the amount of mechanical power that is needed for driving the vehicle 10. It may, however, be advantageous to control the engine 110 and the generator 530 in such a way as to ensure that the engine 110 can always run in a lean-burn mode. This can be achieved by reducing the engine load and using more battery power when the demand for power becomes too high for running in an energy efficient lean-burn mode. Similarly, when low engine loads make it difficult or impossible for the engine 110 to deliver power in a lean-burn mode, the engine load may be increased and the excess electrical power can be stored in the battery pack 121. Such control strategies to ensure that the engine 110 runs exclusively in a lean-burn mode are then to be combined with common control strategies for dividing power demands between the battery pack 121 and the internal combustion engine or range extender 110. In the event that the battery pack 121 is already fully charged, the internal combustion engine 110 may be turned off when the current load level of the internal combustion engine 110 drops below a lean-burn threshold and it is no longer desirable and/or possible to run the engine in a lean-burn mode.

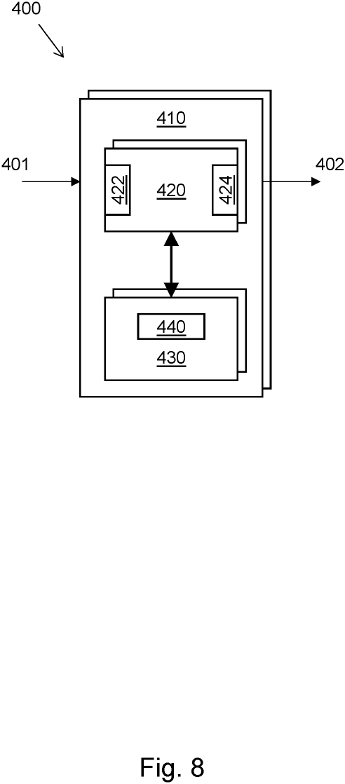

The efficiency and performance of an engine depend on the rotational speed of its output shaft (typically measured in rotations per minute) and the amount of work it has to deliver. Maximum efficiency and performance are typically achieved in a narrow range of engine speed and engine load combinations. By continuously adapting the relevant operational parameters of the engine in accordance with the desired speed and load, the engine’s performance and efficiency can also be optimised when working outside this narrow range. An engine control unit, which will be described in more detail below with reference to FIG. 8, is operatively coupled to the engine 100, 101 to control its operation as a function of different input parameters that at least comprise the current engine load, but preferably also to current engine speed and other relevant parameters.

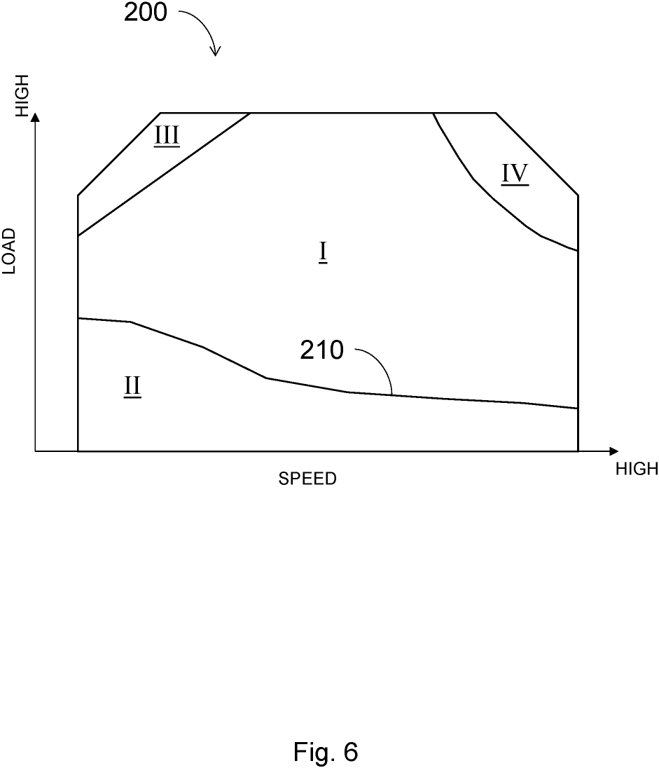

FIG. 6 schematically shows an engine map 200 for use with an embodiment of the invention. The engine map 200 shows different operational regions (I, II, III, IV) for the hybrid engines 100, 101 of FIGS. 1 and 2. Depending on the load and output speed to be delivered by the engine 100, 101, the engine 100, 101 operates in a different operational region.

In region I, the clutch 130 is closed and the internal combustion engine 110 is coupled to the drivetrain. According to the invention, the internal combustion engine 110 runs in a lean-burn mode in the full space of region I, which means that gasoline will be burnt with an excess of air in the air-fuel mixture in the engine’s cylinders, i.e. lambda > 1. For example, a charge with lambda of at least 1.2 or 1.3 is used. The exact mixture of air and fuel, a timing of the fuel injection, valve operation and spark ignition may vary according to the circumstances and engine output demands. While operating in region I, the electric motor 120 is used in one of the three following modes:
Idling. The rotor of the electric motor 120 rotates at the speed of the output shaft of the internal combustion engine 110 (FIG. 1), at the speed of the rear axle 170 (FIG. 3), or at a multiple of such speeds, depending on the gear ratios of any intermediate gear couplings. Friction losses in the electric motor 110 will generally be very small, if not zero.
Torque assisting. Electric power, e.g. from the battery 121, is used to add to the torque provided by the lean-burning internal combustion engine 110.
Power generating. Some of the power provided by the internal combustion engine 110 is used to charge the battery 121.

Efficient and effective strategies for switching between these three modes are generally known in the art and may depend on many input parameters, such as a charging status of the battery 121, fuel tank filling levels, vehicle speed, current fuel efficiency, required total torque, exhaust gas composition, etc.

When the engine load is low, and less fuel is needed for satisfying the power demand of the powertrain, stable combustion in a lean environment gets problematic. The flammability of the charge gets too low for ensuring proper burning of all the fuel. Further, when combustion takes place in smaller isolated pockets instead of in the full cylinder at once, this results in knock, leading to noise and damage to the internal combustion engine 110. To avoid such problems, the hybrid engine 100, 101 of FIGS. 1 and 2 decouples the internal combustion engine 110 from the drivetrain when operating in region II. Operating region 2 thus corresponds to a fully electric mode in which the powertrain is powered by the electric motor 120 only.

The transition between region I and region II is marked by a lean-burn load threshold 210, which is hereby defined as the load level below which stable operation of the internal combustion engine 110 in the lean-burn mode is impossible and/or undesirable. ‘Impossible’ may mean that reduced flammability of the charge makes lean combustion technically completely impossible, or at least too unpredictable and unstable to be suitable for effective use of the internal combustion engine 110. Lean-burn operation of the internal combustion engine 110 may be ‘undesirable’, for example, because of relatively low fuel efficiency or high NOₓ or CO emissions. Similarly, lean operation will be ‘undesirable’ when the exhaust gas temperatures are too low to allow such emissions to be effectively dealt with by the aftertreatment system. Other possible reasons for lean-burn operation not being desirable may, for example, be an excess of other undesirable or legislated emissions, (temporary) noise restrictions, low filling levels of the fuel tank, or a simple user preference to drive in the electric mode.

In a basic embodiment of the invention, the lean-burn load threshold may just be defined by a fixed engine load value. This fixed threshold may, for example, be defined as a percentage (e.g. 10%) of the maximum engine load or expressed in BMEP (e.g. 3 bar). If the vehicle demands an engine load below that fixed value, the engine 100, 101 runs in an electric mode (region II). If the vehicle demands more engine load, the engine 100, 101 operates in the lean-burn mode (region I). In a more advanced embodiment of the invention, as shown in FIG. 6, the lean-burn load threshold 210 is dependent on, for example, the current engine RPM. RPM therein refers to the rotational speed (rotations per minute) of the output shaft of the internal combustion engine 110. In the embodiment of FIG. 1, this rotational speed corresponds with the rotational speed of the rotor of the electric motor 120. In the embodiment of FIG. 3, the rotational speed of the internal combustion engine 110 is a predetermined multiple of the rotational speed of the electric motor 120. Thus, in the electric mode, when the internal combustion engine may not be running, the engine RPM can be determined based on the rotational speed of the rotor of the electric motor 120. An RPM dependent lean-burn load threshold 210 can thus also be determined when the internal combustion engine 110 is not (yet) running.

In addition to the regions I and II, engine map also comprises a region III and a region IV. In region III, the hybrid engine 100, 101 takes advantage of the well-known property of electric motors 120 to be capable of delivering high torque over its full range of available RPMs. In contrast, internal combustion engines 110 typically generate their maximum torque at or near a specific RPM and a reduced output outside that optimum range. The transmission 140 is used (switching gears) to keep close to the optimum RPM range at varying vehicle speeds. By hybrid operation of the engine 100, 101 in region III (low RPM) and region IV (high RPM), high torque can also be delivered at engine speeds for which such torque is not available in the lean-burn internal combustion engine 110. Regions II, III and IV may be operated in a hybrid mode combining lean combustion torque with electric drive, for example operating in region II may comprise operating the electric motor as a generator to move the combustion engine operating point into the lean region.

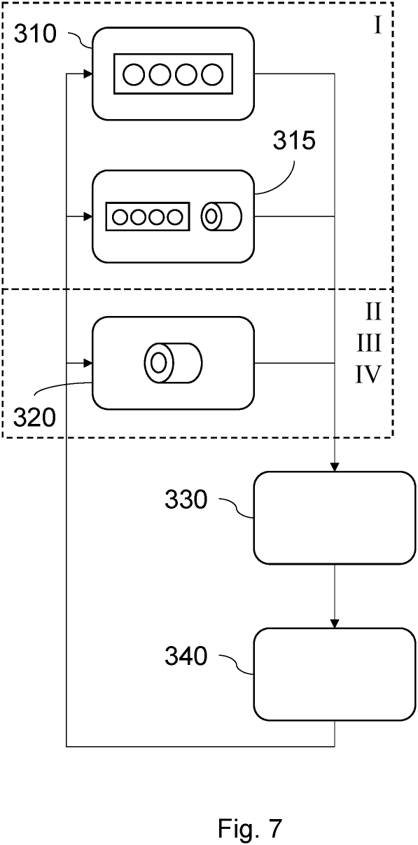

FIG. 7 shows a flow diagram of a possible method according to the invention. The control of the operation of the hybrid engine 100, 101 is a cyclic process. Engine load and other parameters are continuously monitored, while the operation of the hybrid engine 100, 101 is adapted accordingly. To start the explanation of the control process, we’ll start from an engine 100, 101 that is running in a lean-burn mode 310, without any electric assistance. Looking at the engine map 200 of FIG. 6, this means that the engine 100, 101 is operating in region I.

While the full hybrid engine 100, 101 is running, its current load level is monitored in monitoring step 330. The current load level will typically be determined based on a torque model that uses one or more input parameters to determine or estimate the current engine load. Useful parameters to use as input for the torque model are, for example, an acceleration pedal position measured by an acceleration pedal position sensor, or a current speed control setting of a cruise control system. Other parameters that may be useful for estimating the current load level are vehicle speed, road inclination, and vehicle weight information (which may include the weight of any passengers and/or goods that are being transported by the vehicle).

As explained above, the engine management may be completely based on the monitored or estimated current engine load level only, but may take additional parameters into account, such as engine RPM and NOₓ and other emissions. Such additional parameters are also obtained in monitoring step 330 with the help of the appropriate sensors.

In mode selecting step 340, the monitored parameters obtained in monitoring step 330 are used for selecting an appropriate mode of operation for the engine 100, 101. For selecting the most appropriate mode, the engine map 200 of FIG. 6 may be used. This may be done by comparing the current load level to the lean-burn load threshold 210 indicated in the engine map 200. Depending on the current engine load and the current engine RPM, the engine control unit then determines whether to operate the engine 100, 101 in region I, II, III or IV. If, for example, the current load level of the full hybrid engine 100, 101 is below the lean-burn load threshold 210, the engine control unit may decide to decouple the internal combustion engine from the powertrain and to operate the full hybrid engine 100, 101 in an electric mode 320.

If the engine control unit chooses to operate the engine 100, 101 in region II, the internal combustion engine 110 will be decoupled from the drivetrain and the hybrid engine 100, 101 is switched to a fully electric mode 320. If the engine control unit chooses to operate the engine 100, 101 in region I, III or IV, the internal combustion engine 110 will remain coupled to the drivetrain and the hybrid engine 100, 101 and the hybrid engine either stays in the full lean-burn mode 310 or switches to an assisted lean-burn mode 315, wherein the internal combustion engine 110 and the electric motor 120 together provide the demanded torque. As already discussed above, the decision to run the internal combustion engine 110 with or without electric assistance may, for example, depend on a charging status of the battery 121, fuel tank filling levels, current fuel efficiency, vehicle speed, required total torque, exhaust gas composition, etc. When operating in the full lean-burn mode 310, excess power from the internal combustion engine (e.g. produced to operate in a more fuel-efficient spot in the engine map 200) may be used for charging the battery 121. However, charging the battery 121 may be possible in a more energy-efficient manner while coasting or using regenerative braking.

According to an embodiment of the invention, also the current NOₓ emissions are taken into account for selecting the appropriate mode of operation. This may, for example, be done by temporarily overruling the engine map 200 and immediately switching to the fully electric mode 320 whenever a predetermined NOₓ threshold is exceeded. Alternatively, monitored NOₓ emission values may be used as an input for calibrating the lean-burn load threshold 210. If, for example, it turns out that NOₓ emissions can be kept relatively low when operating in areas of the engine map 200, just above the lean-burn threshold 210, the threshold 210 may be lowered. Conversely, the threshold may be raised when experiencing unexpectedly high NOₓ emissions. Such calibration may also alter the shape of the lean-burn threshold 210, if the threshold can be raised for some RPMs, but has to be lowered for others.

With reference to FIG. 8, there is illustrated a simplified example of a control system or engine control unit 400 such as may be adapted to implement the method of FIG. 7 described above. The control system 400 comprises one or more controllers 410 and is configured to operate the internal combustion engine 110 in a lean-burn mode 310, 315 or electric mode 320, to determine the current load level of the full hybrid engine 100, 101, to compare the current load level to the lean-burn load threshold 210, and to couple or decouple the internal combustion engine 110 to/from the drivetrain accordingly in order to operate the full hybrid engine 100, 101 in the appropriate mode.

It is to be understood that the or each controller 410 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 410 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 410 to implement the control techniques described herein (including some or all of the functionality required for the method described herein). The set of instructions could be embedded in said one or more electronic processors of the controller 410; or alternatively, the set of instructions could be provided as software to be executed in the controller 410. A first controller or control unit may be implemented in software run on one or more processors. One or more other controllers or control units may be implemented in software run on one or more processors, optionally the same one or more processors as the first controller or control unit. Other arrangements are also useful.

In the example illustrated in FIG. 8, the or each controller 410 comprises at least one electronic processor 420 having one or more electrical input(s) 422 for receiving one or more input signal(s) 401, such as those described above and one or more electrical output(s) 424 for outputting one or more output signal(s) 402, such as control signals for opening and closing the clutch 130 or for operating the internal combustion engine 110 and the electric motor 120. The or each controller 410 further comprises at least one memory device 430 electrically coupled to the at least one electronic processor 420 and having instructions 440 stored therein.

The, or each, electronic processor 420 may comprise any suitable electronic processor (e.g., a microprocessor, a microcontroller, an ASIC, etc.) that is configured to execute electronic instructions. The, or each, electronic memory device 430 may comprise any suitable memory device and may store a variety of data, information, threshold value(s), lookup tables or other data structures, and/or instructions therein or thereon. In an embodiment, the memory device 430 has information and instructions for software, firmware, programs, algorithms, scripts, applications, etc. stored therein or thereon that may govern all or part of the methodology described herein. The processor, or each, electronic processor 420 may access the memory device 430 and execute and/or use that or those instructions and information to carry out or perform some or all of the functionality and methodology describe herein.

The at least one memory device 430 may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

Example controllers 410 have been described comprising at least one electronic processor 420 configured to execute electronic instructions stored within at least one memory device 430, which when executed causes the electronic processor(s) 420 to carry out the method as hereinbefore described. However, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

It will be appreciated that various changes and modifications can be made to the present invention without departing from the scope of the present application.

1. An engine control unit for a full hybrid engine, the full hybrid engine comprising an internal combustion engine and an electric motor, the internal combustion engine being coupled to the drivetrain via a clutch, the engine control unit being configured to:
operate the internal combustion engine in a lean-burn mode,
determine a current load level of the full hybrid engine,
compare the current load level to a lean-burn load threshold, the lean-burn load threshold defining a load level below which stable operation of the internal combustion engine in the lean-burn mode is impossible and/or undesirable, and
when the current load level of the full hybrid engine is below the lean-burn load threshold, decouple the internal combustion engine from the drivetrain and operate the full hybrid engine in an electric mode.

2. The engine control unit according to claim 1, configured to:
operate the full hybrid engine in the electric mode,
determine the current load level of the full hybrid engine,
compare the current load level to the lean-burn load threshold, and
when the current load level of the full hybrid engine is above the lean-burn load threshold, couple the internal combustion engine to the drivetrain and operate the internal combustion engine in the lean-burn mode.

3. The engine control unit according to claim 1, configured to determine a current RPM of the full hybrid engine, and to determine the lean-burn load threshold in dependence on the current RPM.

4. The engine control unit according to claim 1, configured to determine the current load level of the full hybrid engine in dependence on an electronic signal representative of a current position of an accelerator pedal.

5. The engine control unit according to claim 1, configured to determine the current load level of the full hybrid engine in dependence on an electronic signal representative of a current speed control setting of a cruise control system.

6. The engine control unit according to claim 1, configured to determine the current load level and/or a current RPM of the full hybrid engine using a torque model.

7. The engine control unit according to claim 1, configured to determine a current NOₓ concentration in an exhaust stream of the internal combustion engine, while the internal combustion engine is operating in the lean-burn mode.

8. The engine control unit according to claim 7, configured to compare the current NOₓ concentration to a NOₓ threshold and, when the current NOₓ concentration is above the NOₓ threshold, to decouple the internal combustion engine from the drivetrain and operate the full hybrid engine in the electric mode.

9. The engine control unit according to claim 7, configured to calibrate the lean-burn load threshold based on the current load level and the current NOₓ concentration.

10. An internal combustion engine comprising the engine control unit of claim 1.

11. A full hybrid engine for a drivetrain of a vehicle, the full hybrid engine comprising:
an internal combustion engine,
at least one electric motor,
a clutch for coupling the internal combustion engine to the drivetrain, and
the engine control unit according to claim 1.

12. The full hybrid engine as claimed in claim 11, the full hybrid engine further comprising a generator, mechanically coupled to the internal combustion engine and electrically coupled to the electric motor and/or a battery pack of the vehicle.

13. A powertrain for a vehicle, comprising the full hybrid engine of claim 11.

14. A vehicle comprising full hybrid engine according to claim 13.

15. A method of operating a full hybrid engine for a drivetrain of a vehicle, the full hybrid engine comprising an internal combustion engine and an electric motor, the internal combustion engine being coupled to the drivetrain via a clutch, the method comprising:
operating the internal combustion engine in a lean-burn mode,
determining a current load level of the full hybrid engine,
comparing the current load level to a lean-burn load threshold, the lean-burn load threshold defining a load level below which stable operation of the internal combustion engine in the lean-burn mode is impossible and/or undesirable, and
when the current load level of the full hybrid engine is below the lean-burn load threshold, decoupling the internal combustion engine from the drivetrain and operating the full hybrid engine in an electric mode.

16. A non-transitory computer readable medium comprising computer readable instructions that, when executed by a processor, cause performance of the method of claim 15.

17. An engine control unit for a battery electric vehicle, the battery electric vehicle comprising an internal combustion engine, an electric motor, a battery pack, and a generator, the generator being mechanically coupled to the internal combustion engine and electrically coupled to the electric motor and/or the battery pack, the engine control unit being configured to:
operate the internal combustion engine,
determine a current load level of the internal combustion engine,
compare the current load level to a lean-burn load threshold, the lean-burn load threshold defining a load level below which stable operation of the internal combustion engine in the lean-burn mode is impossible and/or undesirable, and
when the current load level of the internal combustion engine is below the lean-burn load threshold, increase the current load level for charging the battery pack.

18. An internal combustion engine comprising the engine control unit of claim 17.

19. A powertrain for a battery electric vehicle, the powertrain comprising:
an internal combustion engine,
an electric motor,
a battery pack,
a generator, mechanically coupled to the internal combustion engine and electrically coupled to the electric motor and/or the battery pack, and
the engine control unit according to claim 17.

20. A battery electric vehicle comprising the powertrain according to claim 19.
